(19) United States
(12) Patent Application Publication
(10) Pub. No.: US 2026/0070823 A1
(43) Pub. Date: Mar. 12, 2026

(54) METHOD FOR REDUCING TOXICITY OF WASTEWATER

(71) Applicant: Nanjing University, Nanjing (CN)

(72) Inventors: Haidong HU, Nanjing (CN); Chenglong HAN, Nanjing (CN); Hongwei BAI, Nanjing (CN); Kewei LIAO, Nanjing (CN); Hongqiang REN, Nanjing (CN)

(21) Appl. No.: 19/199,345

(22) Filed: May 5, 2025

(30) Foreign Application Priority Data
Sep. 10, 2024 (CN) 202411262129.X

(51) Int. Cl. C02F 3/00; C02F 3/10; C02F 101/30

(52) U.S. Cl. CPC C02F 3/005; C02F 3/106; C02F 2101/30; C02F 2209/20; C02F 2305/14

(57) ABSTRACT

A method for reducing a toxicity of wastewater, including: selecting a working electrode based on a biochemical oxygen demand to chemical oxygen demand (B/C) ratio of the wastewater; constructing a microbial electrochemical system using the graphite rod or the biochar/MoS₂-modified graphite rod as the working electrode; adding a culture solution including the wastewater, sediment, a phosphate buffer solution, and a carbon source to the microbial electrochemical system, cultivating and enriching an electroactive biofilm on the surface of the working electrode in the microbial electrochemical system using chronoamperometry, and periodically refreshing the culture solution until the electroactive biofilm reaches a stable and mature state; and after formation of the electroactive biofilm, introducing the wastewater into the microbial electrochemical system with a matured electroactive biofilm, applying an external voltage to the working electrode, and operating the microbial electrochemical system under intermittent polarization switching between open-circuit and closed-circuit modes.

### CROSS-REFERENCE TO RELATED APPLICATIONS

Pursuant to 35 U.S.C.§ 119 and the Paris Convention Treaty, this application claims foreign priority to Chinese Patent Application No. 202411262129.X filed Sep. 10, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of wastewater treatment, and more particularly to a method for reducing the toxicity of wastewater.

Wastewater from industrial parks, particularly those with high concentrations of industrial activities, is typically collected and processed in centralized treatment facilities. The wastewater often contains a wide range of pollutants, including both known and potentially unidentified toxic organic compounds. While primary and secondary treatment processes are routinely applied, many refractory organic compounds remain in the effluent. The majority (>90%) of the refractory organic compounds are dissolved organic materials, which, upon discharge into water bodies, pose significant threats to human health and the surrounding ecosystems. Recent studies indicate that there is no clear, direct relationship between the reduction in total organic carbon (TOC) levels and a corresponding reduction in the toxicity of organic pollutants present in wastewater. In other words, a reduction in TOC does not necessarily indicate the elimination of toxic organic contaminants from the wastewater. Conventional wastewater treatment methods, which typically focus on reducing general pollution parameters such as chemical oxygen demand (COD) and TOC, are insufficient to meet the growing safety requirements for aquatic ecosystems. As a result, there is an urgent need for more advanced and effective treatment technologies capable of further purifying wastewater and reducing its toxicity, ensuring that effluent discharged from treatment plants does not pose a risk to public health or the environment.

Conventional physical and chemical treatment methods, including ozone oxidation, have been employed to address refractory pollutants. However, the techniques suffer from several limitations, such as high material and energy costs, as well as the generation of toxic by-products. While the methods can reduce the TOC levels in the effluent, they may paradoxically increase the toxicity of the remaining organic compounds. Recently, microbial electrochemical systems (MESs), which combine biodegradation with electrochemical processes in a single integrated system, have emerged as a promising low-energy and sustainable technology for wastewater treatment. However, the application of MESs to industrial wastewater is significantly hindered by the slow biodegradation rates of refractory pollutants, limiting their effectiveness in real-world industrial applications.

### SUMMARY

To solve the previously mentioned problems, the disclosure provides a method for reducing the toxicity of wastewater.

The method comprises:
1) selecting a working electrode based on a biochemical oxygen demand to chemical oxygen demand (B/C) ratio of the wastewater, when the B/C ratio of the wastewater is greater than or equal to 0.25, employing a graphite rod as the working electrode, and when the B/C ratio of the wastewater is less than 0.25 but greater than or equal to 0.1, employing a biochar/MoS₂-modified graphite rod as the working electrode;
2) constructing a microbial electrochemical system using the graphite rod or the biochar/MoS₂-modified graphite rod as the working electrode;
3) adding a culture solution comprising the wastewater, sediment, a phosphate buffer solution, and a carbon source to the microbial electrochemical system, cultivating and enriching an electroactive biofilm on a surface of the working electrode in the microbial electrochemical system using chronoamperometry, and periodically refreshing the culture solution until the electroactive biofilm reaches a stable and mature state; and
4) after formation of the electroactive biofilm, introducing the wastewater into the microbial electrochemical system with a matured electroactive biofilm, applying an external voltage to the working electrode, and operating the microbial electrochemical system under intermittent polarization switching between open-circuit and closed-circuit modes, thereby achieving toxicity reduction of the wastewater.

The term “B/C ratio”, as used herein, refers to a ratio of five-day biochemical oxygen demand (BOD₅) to chemical oxygen demand (COD).

In a class of this embodiment, the biochar/MoS₂-modified graphite rod is prepared by depositing a biochar/MoS₂ composite material onto the surface of the graphite rod.

In a class of this embodiment, in 1), the biochar/MoS₂-modified graphite rod is prepared by uniformly dispersing a biochar/MoS₂ composite material in a buffer solution having a pH between 5.5 and 6.5 and performing cyclic voltammetry to deposit biochar or MoS₂ on the surface of the graphite rod.

In a class of this embodiment, a concentration of the biochar/MoS₂ composite material in the buffer solution is between 0.5 and 1.0 g/L.

In a class of this embodiment, three parameters are used when performing cyclic voltammetry to deposit biochar or MoS₂ on the surface of the graphite rod: (a) a scan rate is from 50 mV/s to 100 mV/s; (b) a potential window is between −0.8 V and 1.0 V relative to an Ag/AgCl reference electrode; and (c) a number of scan cycles is between 30 and 60.

In a class of this embodiment, the biochar/MoS₂ composite material comprises a biochar component derived from date pits.

In certain embodiments, the biochar/MoS₂ composite material is prepared as follows: date pits are obtained from peeled and sliced dates, and ground into a fine powder; the fine powder is calcined to form an intermediate product; the intermediate product is then treated in an aqueous potassium hydroxide (KOH) solution; the resulting powder is filtered, and pyrolyzed at a high temperature under a nitrogen atmosphere; the pyrolyzed product is washed to neutral pH to yield a porous biochar material; the porous biochar material is mixed with ammonium molybdate, thiourea, and a date peel extract comprising glucose and phenolic compounds to form a mixture; the mixture is stirred uniformly and transferred into an autoclave for a hydrothermal reaction for 12 hours to form a product; and after natural cooling, the product is centrifuged and washed to yield the biochar/MoS₂ composite material.

In a class of this embodiment, the buffer solution is a citrate buffer having a concentration of 0.01 M to 0.1 M.

In a class of this embodiment, in 2), the microbial electrochemical system comprises a reactor, a counter electrode, a reference electrode, a working electrode, an electrochemical workstation, and a plurality of electrical wires; the counter electrode, the reference electrode, and the working electrode are vertically inserted into the reactor and are electrically connected to the electrochemical workstation via the plurality of electrical wires.

In a class of this embodiment, in 3), the wastewater, sediment, and the phosphate buffer solution are mixed at a volumetric ratio of 1-2:6-8:1-2; sodium acetate is added as a carbon source at a concentration of 0.5 g/L to 1 g/L; for every cultivation cycle, the culture solution is refreshed when an output current drops less than or equal to 10⁻⁵ A; and the electroactive biofilm reaches a mature state when a current density exceeds 4.69 A/m².

In a class of this embodiment, each cultivation cycle lasts for 2 to 4 days, and a total cultivation period is between 25 and 35 days.

In a class of this embodiment, in 4), the intermittent polarization switching between open-circuit and closed-circuit modes is that the microbial electrochemical system is operated in the open-circuit mode for 6-12 hours, and then in the closed-circuit mode for 6-12 hours.

In a class of this embodiment, in 4), the wastewater is treated for 24-48 hours.

In a class of this embodiment, in 4), the external voltage applied to the working electrode is in a range of 0-0.6 V relative to the Ag/AgCl reference electrode.

The microbial electrochemical system utilizes the biochar/MoS₂ composite material as a key component for electron storage and release. The microbial electrochemical system operates under intermittent polarization switching between open-circuit and closed-circuit modes. During the open-circuit mode, electrons generated by electroactive microorganisms through the oxidation of organic matter are temporarily stored within the biochar/MoS₂ composite material. Upon transitioning to the closed-circuit mode, the stored electrons are released into the circuit, resulting in an enhanced output current density. The dynamic flux of electrons stimulates the metabolic activity of the electroactive microorganisms. Moreover, the combination of the intermittent polarization mode and the biochar/MoS₂ composite material induces the upregulation of microbial redox-active electron carriers, thereby increasing intracellular electron flux and accelerating extracellular electron transfer (EET). The enhanced electron transfer efficiency between the electroactive microorganisms and the electrode interface enables more efficient utilization of pollutants as electron donors, facilitating the transformation and degradation of pollutants. As a result, the microbial electrochemical system contributes to a reduction in the toxicity of the wastewater, particularly under conditions characterized by low B/C ratios.

The following advantages are associated with the method for reducing the toxicity of wastewater of the disclosure:
1. The method provides a treatment strategy for the wastewaters with varying degrees of biodegradability, characterized by B/C ratios.
2. Specifically, for the wastewater with a B/C ratio in the range of 0.1≤B/C<0.25, the use of the graphite rod electrode modified with the biochar/MoS₂ composite material, in combination with the intermittent polarization mode, enhances pollutant removal efficiency. The configuration significantly reduces significant wastewater treatment time while simultaneously decreasing energy consumption per unit of the treated industrial water. Under the low-energy conditions, the microbial electrochemical system effectively mitigates the toxicity of refractory organic pollutants. The treatment addresses a critical challenge in conventional high-energy technologies, which often reduce total organic carbon (TOC) levels without effectively lowering effluent toxicity. The disclosed method offers a significant advancement in achieving regulatory compliance and safe discharge of industrial effluents.
3. The biochar/MoS₂ composite material comprises biochar derived from date seed biomass, which exhibits enhanced charge storage and discharge characteristics, thereby improving the overall electrochemical performance of the electrode.
4. The intermittent polarization mode enables targeted application of external electrical energy to accelerate contaminant degradation. Simultaneously, by limiting the duration of applied voltage, the microbial electrochemical system reduces overall power input. The disclosed method demonstrates low energy demand, operational simplicity, and scalability, making it suitable for widespread industrial wastewater treatment applications. The disclosed method delivers both environmental and socioeconomic benefits, particularly in contexts requiring the treatment of persistent and toxic industrial effluents.

### BRIEF DESCRIPTION OF THE DRAWINGS

FIG. 1 is a schematic diagram of a microbial electrochemical system according to one example of the disclosure;

FIG. 2 depicts the time-current profiles for Example 1, Comparative Example 1, and Comparative Example 2;

FIG. 3 shows the concentrations and removal efficiencies of TOC in the effluent for Example 1, Comparative Example 1, and Comparative Example 2;

FIG. 4 illustrates the effluent toxicity results for Example 1, Comparative Example 1, and Comparative Example 2;

FIG. 5 depicts the time-current profiles for Example 2 and Comparative Example 3;

FIG. 6 shows the concentrations and removal efficiencies of TOC in the effluent for Example 2, Comparative Example 3, and Comparative Example 4; and

FIG. 7 illustrates the effluent toxicity results for Example 2, Comparative Example 3, and Comparative Example 4.

In the drawings, the following reference numbers are used: 1. Reactor; 2. Counter electrode; 3. Reference electrode; 4. Working electrode; and 5. Electrochemical workstation.

### DETAILED DESCRIPTION

To further illustrate the disclosure, embodiments detailing a method for reducing the toxicity of wastewater are described below. It should be noted that the following embodiments are intended to describe and not to limit the disclosure.

### Example 1

In Example 1, the industrial wastewater to be treated was sourced from an industrial park. The industrial wastewater had an average pH of 7.2, an average COD of 82.67 mg/L, a B/C ratio of 0.38, and an average TOC concentration of 24.75 mg/L.

The toxicity of the industrial wastewater was assessed using a zebrafish embryo bioassay. The deformity rate of the zebrafish embryos, assessed at 72 hours post-fertilization (72 hpf), was found to be 80.5%, indicating a high level of toxicity in the industrial wastewater.

A method for treating the industrial wastewater comprised:

### (1) Construction of a Microbial Electrochemical System

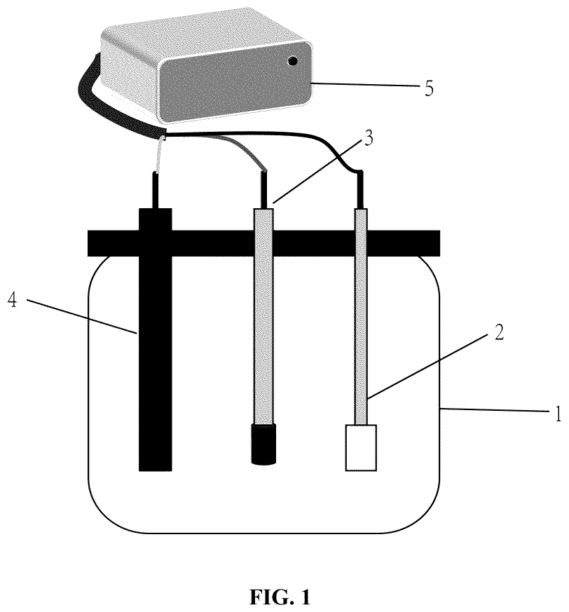

As shown in FIG. 1, a microbial electrochemical system comprises a reactor 1, a counter electrode 2, a reference electrode 3, a working electrode 4, an electrochemical workstation 5, and a plurality of electrical wires.

The industrial wastewater had a B/C ratio of greater than 0.25. The microbial electrochemical system was configured as a three-electrode system. A graphite rod was used as the working electrode. A platinum sheet was used as the counter electrode. A silver (Ag) electrode coated with silver chloride (AgCl) was used as the reference electrode. The reactor was a cylindrical glass vessel having a capacity of 120 mL. The cylindrical glass vessel was sealed with a polytetrafluoroethylene (PTFE) lid during both the cultivation process and the electrochemical operation phase.

### (2) Enrichment and Cultivation of Electroactive Biofilm

Sediment, industrial wastewater, and a phosphate buffer solution were mixed in a volumetric ratio of 1:8:1 to form a mixture solution. Sodium acetate was added as a carbon source at a concentration of 0.5 g/L to form a culture solution. The culture solution was added to the reactor. The reactor was electrically connected to the electrochemical workstation. The microbial electrochemical system is operated using chronoamperometry to cultivate an electroactive biofilm on the surface of the working electrode. The culture solution was replaced when the current generated by the electroactive biofilm dropped less than or equal to 10⁻⁵ A. The cultivation process was continued for 30 days. The electroactive biofilm was considered mature when the current density exceeded 4.69 A/m².

### (3) Operation of the Microbial Electrochemical System in an Intermittent Polarization Mode

After formation of the electroactive biofilm, only the industrial wastewater to be treated was introduced to the reactor. No additional buffer solution or carbon source was added. An external voltage of 0.6 V (relative to the Ag/AgCl reference electrode) was applied to the working electrode using the electrochemical workstation. The microbial electrochemical system was operated in an intermittent polarization mode, with 12 hours in open-circuit mode followed by 12 hours in closed-circuit mode. After 48 hours of operation, the effluent was collected and filtered through a 0.45 μm membrane. The concentrations of COD and TOC in the effluent were measured. The toxicity of the effluent was then determined using the zebrafish embryo bioassay.

### Comparative Example 1

The difference between Comparative Example 1 and Example 1 lies in 3), the external voltage was continuously applied without manual interruption. Accordingly, the microbial electrochemical system was operated under a continuous polarization mode.

### Comparative Example 2

The difference between Comparative Example 2 and Example 1 lies in 3), no external voltage was applied to the microbial electrochemical system. As a result, the microbial electrochemical system was operated in an open-circuit mode without polarization.

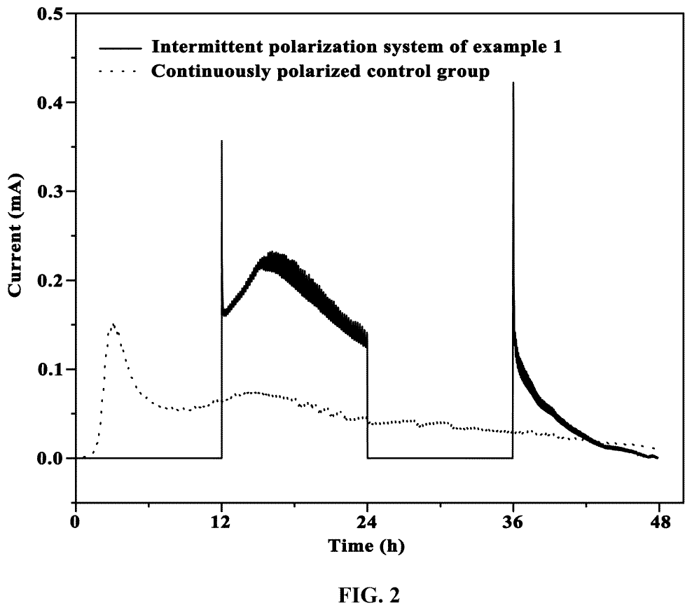

The time-current graphs for Example 1 and Comparative Example 1 are shown in FIG. 2. In Example 1, which was operated under the intermittent polarization mode, the maximum output current reached 0.42 mA, approximately 2.8 times higher than that observed in Comparative Example 1 (0.15 mA), which was operated under a continuous polarization mode. In addition to the peak current, the steady-state current during the closed-circuit mode in Example 1 was also higher than that in Comparative Example 1. The observed output current was primarily attributed to the metabolic activity of electroactive microorganisms at the anode, which transferred electrons to the working electrode. Under the intermittent polarization mode, the electroactive microorganisms accumulated electrons during the open-circuit mode. Upon reapplication of the external voltage (i.e., during the closed-circuit mode), a surge in the current was observed, indicating enhanced electrochemical activity of the microbial consortium.

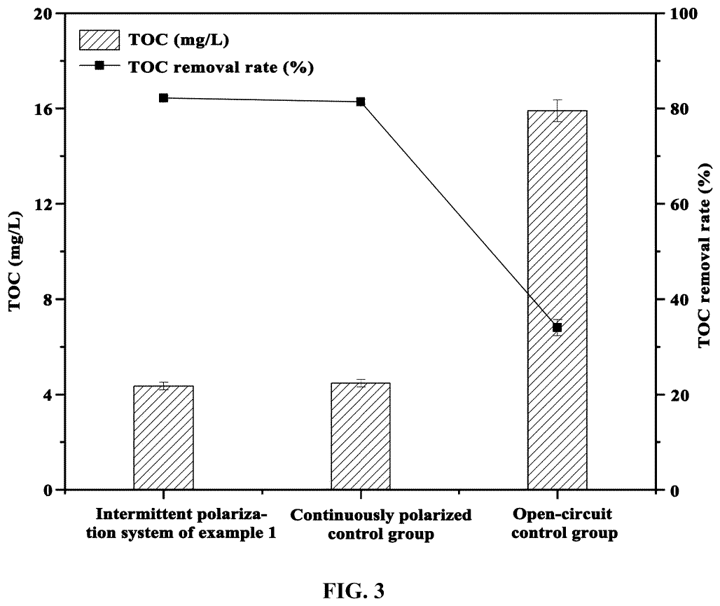

FIG. 3 illustrates the concentrations and removal efficiencies of TOC in the effluents of Example 1, Comparative Example 1, and Comparative Example 2. The microbial electrochemical system in Example 1 and Comparative Example 1 demonstrated high TOC removal efficiencies of 82.2% and 81.4%, respectively. By contrast, Comparative Example 2, which was operated without the application of the external voltage, achieved a TOC removal efficiency of only 34%. Correspondingly, the COD values in the effluents were measured at 15.8 mg/L for Example 1, 16.7 mg/L for Comparative Example 1, and 54 mg/L for Comparative Example 2. The results demonstrate that the application of external voltage-particularly under an intermittent polarization mode-substantially improves the performance of the microbial electrochemical system in removing organic pollutants from the industrial wastewater.

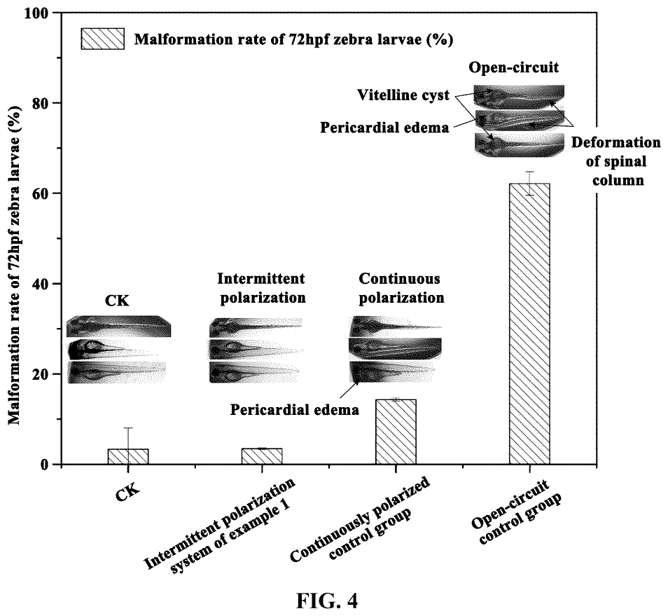

FIG. 4 shows the effluent toxicity levels for Example 1, Comparative Example 1, and Comparative Example 2, as determined by the zebrafish embryo bioassay. In Comparative Example 2, the deformity rate of the zebrafish embryos at 72 hours post-fertilization (hpf) was 62.1%, indicating a high level of biological toxicity. While Comparative Example 1 showed a reduced TOC concentration, the deformity rate of the zebrafish embryos remained at 14.3%, suggesting residual toxicity. In contrast, the effluent from Example 1 exhibited a deformity rate of only 3.5%, which was statistically indistinguishable from that of the negative control group (CK), at 3.3%. The results demonstrate that the disclosed method, when operated under the intermittent polarization mode, effectively reduces effluent toxicity to near-background levels, thereby minimizing environmental risks to aquatic organisms. Furthermore, the disclosed method achieves comparable treatment efficacy while applying the external voltage for only 50% of the operation time, offering a significant reduction in energy consumption relative to the continuous polarization mode.

### Example 2

In Example 2, the industrial wastewater to be treated was sourced from an industrial park. The industrial wastewater had an average pH of 7.3, an average COD of 85.33 mg/L, a B/C ratio of 0.22, and an average TOC concentration of 25.12 mg/L. The toxicity of the industrial wastewater was assessed using a zebrafish embryo bioassay. The deformity rate of the zebrafish embryos, assessed at 72 hours post-fertilization (72 hpf) was found to be 76.4%, indicating a high level of toxicity in the industrial wastewater.

A method for treating the industrial wastewater comprised:

### (1) Construction of a Microbial Electrochemical System

The industrial wastewater had a B/C ratio of less than 0.25 but not less than 0.1. The microbial electrochemical system was configured as a three-electrode system. A biochar/MoS₂-modified graphite rod was employed as the working electrode, a platinum sheet was employed as the counter electrode, and a silver (Ag) electrode coated with silver chloride (AgCl) was used as the reference electrode. The reactor comprised a cylindrical vessel having a diameter of 5 cm, a height of 5 cm, and a capacity of 120 mL. The biochar/MoS₂ composite material and a 0.01 M citrate buffer (pH 6.5) were added to the reactor and uniformly dispersed via rapid stirring, with the concentration of the biochar/MoS₂ composite material maintained at 0.5 g/L. Subsequently, the reactor was electrically connected to the electrochemical workstation. The graphite rod was modified by cyclic voltammetry at a scan rate of 100 mV/s within a potential range from −0.8 V to 1.0 V relative to the Ag/AgCl reference electrode, for a total of 30 cycles. The modified electrode was then dried at 25° C.

The biochar/MoS₂ composite material was prepared as follows: Date pits obtained from peeled and sliced dates were ground into a fine powder. The powder was calcined at 600° C. under a nitrogen atmosphere for 5 hours to yield an intermediate product. The intermediate product was immersed in a 3 M KOH solution and maintained for 8 hours, followed by filtration and pyrolysis at 1000° C. under nitrogen for 4 hours. The resulting powder was washed to neutrality with ultrapure water to obtain a porous biochar material. Subsequently, 10 g of the porous biochar material was mixed with 0.65 g of ammonium molybdate, 0.52 g of thiourea, and a date peel extract comprising glucose and phenolic compounds to form a uniform suspension. The suspension was transferred to an autoclave and subjected to a hydrothermal reaction at 170° C. for 12 hours. After natural cooling to room temperature, the reaction mixture was centrifuged and washed several times with ultrapure water to yield the biochar/MoS₂ composite material.

### (2) Enrichment and Cultivation of Electroactive Biofilm

Sediment, industrial wastewater, and a phosphate buffer solution were mixed in a volumetric ratio of 1:8:1 to form a mixture solution. Sodium acetate was added as a carbon source at a concentration of 1 g/L to form a culture solution. The culture solution was added to the reactor. The reactor was electrically connected to the electrochemical workstation. The microbial electrochemical system is operated using chronoamperometry to cultivate an electroactive biofilm on the surface of the working electrode. The culture solution was replaced when the current generated by the electroactive biofilm dropped less than or equal to 10⁻⁵ A. The cultivation process was continued for 30 days. The electroactive biofilm was considered mature when the current density exceeded 4.69 A/m².

### (3) Operation of the Microbial Electrochemical System in an Intermittent Polarization Mode

After formation of the electroactive biofilm, only the industrial wastewater to be treated was introduced to the reactor. No additional buffer solution or carbon source was added. An external voltage of 0.6 V (relative to the Ag/AgCl reference electrode) was applied to the working electrode using the electrochemical workstation. The microbial electrochemical system was operated in an intermittent polarization mode, with 12 hours in open-circuit mode followed by 12 hours in closed-circuit mode. After 24 hours of operation, the effluent was collected and filtered through a 0.45 μm membrane. The concentrations of COD and TOC in the effluent were measured. The toxicity of the effluent was then determined using the zebrafish embryo bioassay.

### Comparative Example 3

Comparative Example 3 differs from Example 2 is that an unmodified graphite rod was used as the working electrode, serving as a control group.

### Comparative Example 4

Comparative Example 4 differs from Example 2 is that an unmodified graphite rod was used as the working electrode, and the exposure time to the industrial wastewater in 3) was extended to 48 hours.

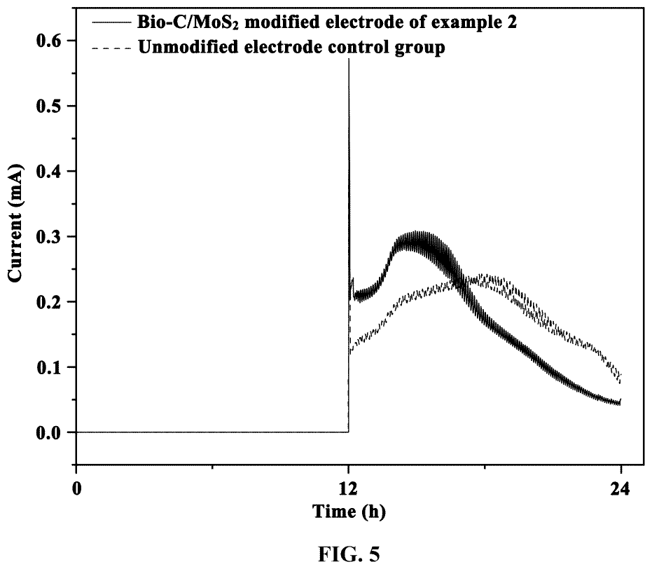

Referring to FIG. 5, time-current profiles of Example 2 and Comparative Example 3 are shown. As illustrated, the biochar/MoS₂-modified graphite rod electrode used in Example 2 exhibited a peak current of approximately 0.57 mA, representing a 1.5-fold increase compared to the peak current (0.37 mA) observed with the unmodified graphite rod electrode of Comparative Example 3. Moreover, during the closed-circuit mode, the steady-state current in Example 2 remained higher than that of Comparative Example 3. Under the intermittent polarization mode, the electroactive microorganisms accumulated electrons during the open-circuit mode. The enhanced current response observed in Example 2 indicates that the biochar/MoS₂ modification improves the electron storage capacity and promotes extracellular electron transfer, potentially through the upregulation of redox-active proteins expressed by the electroactive microorganisms.

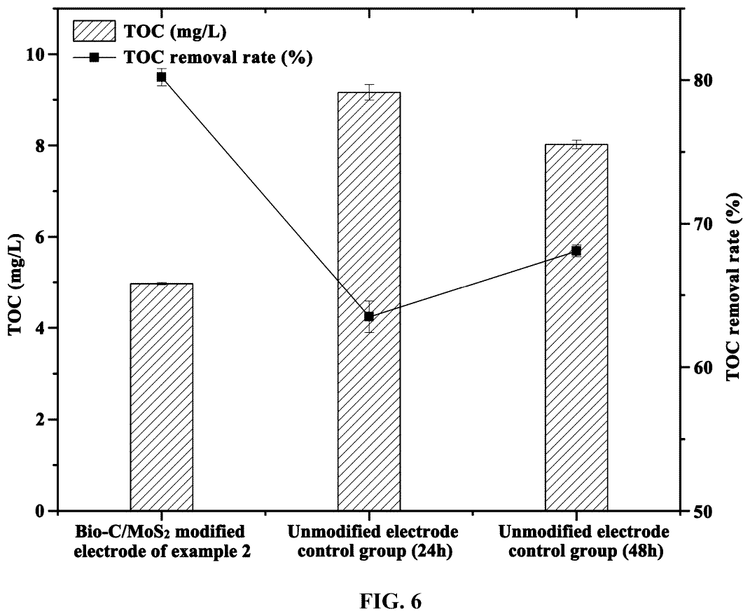

Referring to FIG. 6, the concentrations and removal efficiencies of TOC in the effluent for Example 2, Comparative Example 3, and Comparative Example 4 are shown. As illustrated, the biochar/MoS₂-modified graphite rod electrode employed in Example 2 effectively removed the majority of refractory organic compounds from the industrial wastewater within a 24-hour treatment period, achieving a TOC removal efficiency of 80.3%. In contrast, the unmodified graphite rod electrode used in Comparative Example 3 achieved a TOC removal efficiency of 63.6% under the identical treatment conditions. In Comparative Example 4, although the treatment duration was extended to 48 hours, the TOC removal efficiency remained below 70%. The results indicate that the microbial electrochemical system incorporating the biochar/MoS₂-modified rod electrode exhibits enhanced performance in degrading recalcitrant organic pollutants under the intermittent polarization mode.

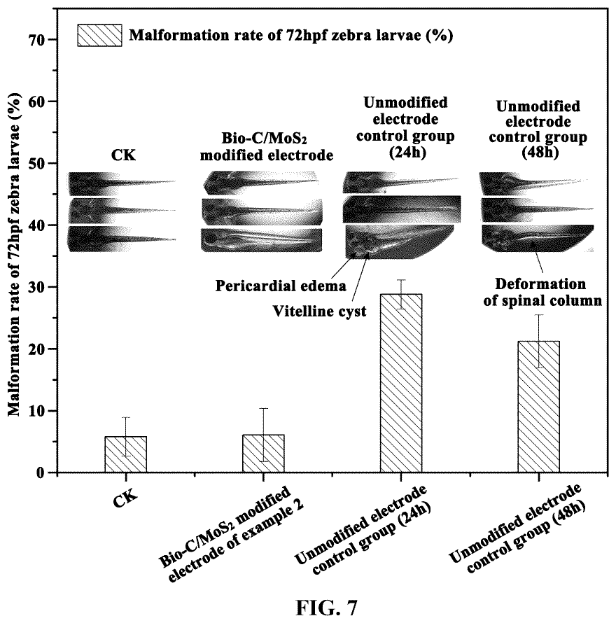

Referring to FIG. 7, the effluent toxicity results for Example 2, Comparative Example 3, and Comparative Example 4 are shown. As illustrated, the effluent from the microbial electrochemical system using the unmodified graphite rod electrodes caused malformations in zebrafish embryos at rates of 28.8% after 24 hours of exposure and 21.2% after 48 hours of exposure, indicating residual biological toxicity. In contrast, the effluent from the microbial electrochemical system using the biochar/MoS₂-modified graphite rod electrode in Example 2 caused malformations in only 6.1% of zebrafish embryos, which was statistically comparable to the control group (CK), which showed a rate of 5.8%. The results indicate that the disclosed method significantly reduces the biological toxicity of refractory industrial wastewater. The reduction in effluent toxicity lowers ecological risks to aquatic organisms and facilitates safer and more environmentally responsible discharge of treated industrial wastewater.

### Example 3

In Example 3, the refining industrial wastewater was collected for treatment. The refining industrial wastewater had an average pH of 6.9, an average COD of 102 mg/L, a B/C ratio of 0.18, and an average TOC concentration of 31.44 mg/L. The toxicity of the refining industrial wastewater was assessed using a zebrafish embryo assay. The deformity rate of the zebrafish embryos, assessed at 72 hours post-fertilization (72 hpf), was found to be 76.4%, indicating a high level of toxicity in the industrial wastewater.

Example 3 was conducted under similar conditions to Example 2, except for the preparation of the biochar/MoS₂-modified graphite rod electrode. In Example 3, the biochar/MoS₂ composite material and a 0.1 M citrate buffer (pH=5.5) were introduced into the reactor and rapidly stirred to ensure uniform distribution at a final concentration of 1 g/L. The electrode modification was performed by applying cyclic voltammetry using the electrochemical workstation at a scan rate of 50 mV/s over a potential range from −0.8V to 1.0 V relative to the Ag/AgCl reference electrode, for a total of 60 cycles. After operation, the average TOC concentration in the effluent was reduced to 5.32 mg/L. The deformity rate in the zebrafish embryos exposed to the effluent decreased by 90%, with the average deformity rate reaching 6.14%. The results demonstrate a reduction in biological toxicity in the treated refining industrial wastewater.

It will be obvious to those skilled in the art that changes and modifications may be made, and therefore, the aim in the appended claims is to cover all such changes and modifications.

What is claimed is:

1. A method for reducing a toxicity of wastewater, comprising:
1) selecting a working electrode based on a biochemical oxygen demand to chemical oxygen demand (B/C) ratio of the wastewater, when the B/C ratio of the wastewater is greater than or equal to 0.25, employing a graphite rod as the working electrode, and when the B/C ratio of the wastewater is less than 0.25 but greater than or equal to 0.1, employing a biochar/MoS₂-modified graphite rod as the working electrode;
2) constructing a microbial electrochemical system using the graphite rod or the biochar/MoS₂-modified graphite rod as the working electrode;
3) adding a culture solution comprising the wastewater, sediment, a phosphate buffer solution, and a carbon source to the microbial electrochemical system, cultivating and enriching an electroactive biofilm on a surface of the working electrode in the microbial electrochemical system using chronoamperometry, and periodically refreshing the culture solution until the electroactive biofilm reaches a stable and mature state; and
4) after formation of the electroactive biofilm, introducing the wastewater into the microbial electrochemical system with a matured electroactive biofilm, applying an external voltage to the working electrode, and operating the microbial electrochemical system under intermittent polarization switching between open-circuit and closed-circuit modes, thereby achieving toxicity reduction of the wastewater.

2. The method of claim 1, wherein the biochar/MoS₂-modified graphite rod is prepared by uniformly dispersing a biochar/MoS₂ composite material in a buffer solution having a pH between 5.5 and 6.5 and performing cyclic voltammetry to deposit biochar or MoS₂ on a surface of the graphite rod.

3. The method of claim 2, wherein a concentration of the biochar/MoS₂ composite material in the buffer solution is between 0.5 and 1.0 g/L.

4. The method of claim 2, wherein three parameters are used when performing cyclic voltammetry to deposit biochar or MoS₂ on the surface of the graphite rod: (a) a scan rate is from 50 mV/s to 100 mV/s; (b) a potential window is between −0.8 V and 1.0 V relative to an Ag/AgCl reference electrode; and (c) a number of scan cycles is between 30 and 60.

5. The method of claim 1, wherein in 4), the intermittent polarization switching between open-circuit and closed-circuit modes is that the microbial electrochemical system is operated in the open-circuit mode for 6-12 hours, and then in the closed-circuit mode for 6-12 hours.

6. The method of claim 2, wherein the biochar/MoS₂ composite material comprises a biochar component derived from date pits.

7. The method of claim 1, wherein in 4), the wastewater is treated for 24-48 hours.

8. The method of claim 1, wherein in 3), the wastewater, the sediment, and the phosphate buffer solution are mixed in a volumetric ratio of 1-2:6-8:1-2; sodium acetate is added as a carbon source at a concentration of 0.5 g/L to 1 g/L; for every cultivation cycle, the culture solution is refreshed when an output current drops less than or equal to 10⁻⁵ A; and the electroactive biofilm reaches a mature state when a current density exceeds 4.69 A/m².

9. The method of claim 8, wherein each cultivation cycle lasts for 2 to 4 days, and a total cultivation period is between 25 and 35 days.

10. The method of claim 1, wherein in 4) the external voltage applied to the working electrode is in a range of 0-0.6 V relative to an Ag/AgCl reference electrode.
